(19) United States
(12) Patent Application Publication
(10) Pub. No.: US 2009/0017427 A1
(43) Pub. Date: Jan. 15, 2009

(54) Intelligent Math Problem Generation

(75) Inventors: William B. Kunz, Seattle, WA (US); Timothy J. Hoffman, Redmond, WA (US); Luke Kelly, Bellevue, WA (US); Jinsong Yu, Sammamish, WA (US); Larry J. Israel, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/776,564

(22) Filed: Jul. 12, 2007

(51) Int. Cl. G09B 19/02

(52) U.S. Cl. 434/188

(57) ABSTRACT

A problem generator that takes an input as a math problem, analyzes the math problem, and intelligently spawns similar example problem types. The output is a set of math problems based on the conditions set during analysis and customization. For example, if the original problem deals with linear equations, this will be detected during analysis and used to spawn other linear equations as problems. Moreover, if the answer to the original problem is in integer format, so will the answers to the spawned problems. A customizable UI is designed to allow further customization of problem conditions to generate an accurate set of problems based on the initial input. Problem generator templates can be created, shared and modified for distribution and/or future use. Additionally, problem generation APIs can be extended for external code to automate and consume generated math problems.

### BACKGROUND

The advances in computing hardware and software are typically complimentary. In other words, advances in hardware provide a platform for richer and more complex software, and the advances in software can impact further improvements in the hardware. The rapid evolution of such hardware and software provides tools for research, business systems, and learning.

In an academic environment, for example, students and teachers are now required to use computers to some extent for assignments, examinations, presentations, etc. The technical arts such as mathematics, physics and chemistry typically pose a significant challenge to students who need to learn one or more of these subjects as a foundation for graduation.

The generation of problems has educational value to teachers and students. Teachers can use problem generation to create math problems and examples for in-class discussion, assignments and examinations. In the context of mathematics, for example, problem generation can expedite the versioning of exams which is often critical to math teams with multiple classes in which students study and are tested on the same math areas. Students can use problem generation to create math problems to test their understanding of math concepts.

Computer algebra systems (including computer algebra software, graphing calculator software, and handheld graphing calculators) can generally perform mathematical calculations and solve equations, and display the final results. However, existing computer algebra systems cannot generate problems with manageable, varying criteria, and conditions.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture includes an intelligent problem generator that takes an input of a math problem, analyzes the math problem, and intelligently spawns example problems based on the conditions of the input problem. Customization conditions are available to further specify and constrain the types of problems to be generated. The output is a set of math problem types similar to the input problem and based on the conditions set during analysis and customization. For example, if the original problem is in the form of a linear equation, this will be detected during analysis and used to spawn other linear equations as problems. Moreover, if the answer to the original problem is in integer format, so will the answers to the spawned problems. The number of possible problems depends on the conditions set during analysis such that the more constraining the conditions, the fewer problems can be generated.

In another embodiment, problem generation is based on analyzing and interpreting user input and intelligently setting conditions based on the interpreted input. Furthermore, a customizable UI is designed to allow further customization of problem conditions to generate an accurate set of problems based on the initial input. Problem generator templates can be created, shared and modified for distribution and/or future use. Additionally, problem generation APIs can be extended for external code to automate and consume generated math problems.

In still another implementation thereof, a decision-theoretic component is provided that employs probabilistic and/or statistical-based analysis to learn and reason about user activities and accessed documents, and in response thereto, can prognose or infer an action that a user desires to be automatically performed.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a general computer-implemented problem generation system.

FIG. 2 illustrates a more detailed system for problem generation in accordance with the disclosed architecture.

FIG. 3 illustrates a system that employs a machine learning and reasoning component which facilitates automating one or more features.

FIG. 4 illustrates a system for providing example problem types in a multi-client environment.

FIG. 5 illustrates a method of generating a problem.

FIG. 6 illustrates a more detailed method of generating a math problem.

FIG.7 illustrates a screenshot of a UI wizard for entering a purely numeric math problem and viewing a generalized expression.

FIG. 8 illustrates a second screenshot of the UI wizard for entering a multi-variable math problem and viewing a generalized expression.

FIG. 9 illustrates a third screenshot of the UI wizard for entering a quadratic math problem and viewing a generalized expression.

FIG. 10 illustrates a fourth screenshot of the UI wizard for entering a sine math problem and viewing a generalized expression.

FIG. 11 illustrates a block diagram of a computing system operable to execute intelligent problem generation in accordance with the disclosed architecture.

FIG. 12 illustrates a schematic block diagram of an exemplary client/server computing environment for intelligent problem generation.

### DETAILED DESCRIPTION

A problem generator architecture is disclosed that takes as input a math problem in a specific form, analyzes the math problem, and intelligently spawns example problems of the same type in a generalized form. No longer are example questions obtained by randomly sampling a library of previously-assembled questions. Here, the spawned math problem types are derived randomly and algorithmically based on process constraints and the characteristics of the original (or parent) math problem.

In one academic example, a math teacher needs to create problems for weekly quizzes to be handed out in class. The teacher uses the math problem generator to create four unique sets of fifteen algebra problems. The problems are then printed for distribution in class. With four unique quizzes, the teacher has versioned the quizzes and distributed these versions randomly through the class. In other words, the quizzes need not be identical and the answers are secured in a computing system. When generating the problems, an answer key option can be auto-generated to make checking of the quizzes a more efficient process.

In another example, a first-year college math student needs a refresher on calculus learned some time ago in high school. Notes may be lost or misplaced and books sold and unavailable. By running the problem generator application, the student can enter one example provided by a teacher's assistant, for example, and then quickly spawn a number of similar problems. Based on this more efficient review process, the student realizes that additional review is required in certain areas related to the definite integral and can work on this area before moving on.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

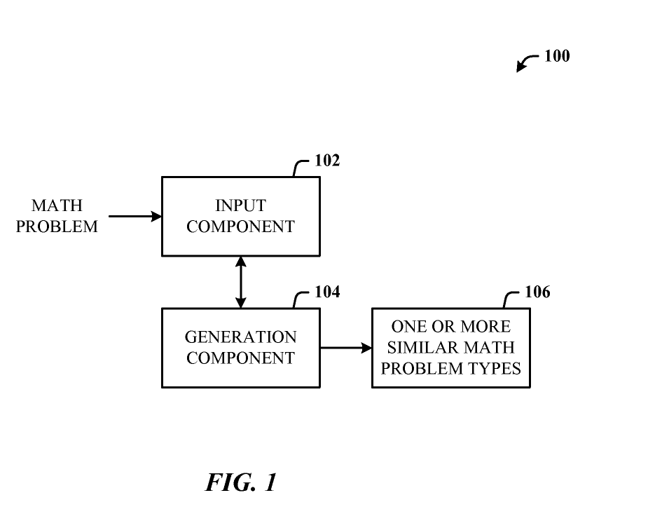

Referring initially to the drawings, FIG. 1 illustrates a general computer-implemented problem generation system 100. The system 100 includes an input component 102 for receiving a math problem and a generation component 104 for algorithmically deriving one or more similar math problem types 106 based on the math problem. For example, if the originally input math problem is a quadratic equation, the general form of the expression will be determined automatically such that other quadratic equations can be spawned. Similarly, if the input problem is a differential equation, the spawned examples will be other differential equations. Not only are the spawned equations provided, but also the answers, so that the user can obtain immediate feedback as to the progress made when working through the problems.

Generally, intelligent math problem generation is divided into three main stages: a create stage a user initiates and inputs a type of math problem to be generated; a modify stage for modifying conditions (or constraints) to influence more accurately the type of problems to be generated; and a generate stage for specifying the number of problems to be generated. The modify stage can be made optional such that the user relies on the default generated conditions rather than overriding the defaults with user-defined conditions.

It is also within contemplation of the subject architecture that based on the level of difficulty of the input problem, spawned problems can be form different areas of the problem environment, but at the same level of difficulty. For example, if the input problem is a low level of difficulty in algebra, a spawned example can be a low level of difficulty in geometry, or business math, or physics. This can be configured by the constraints or conditions.

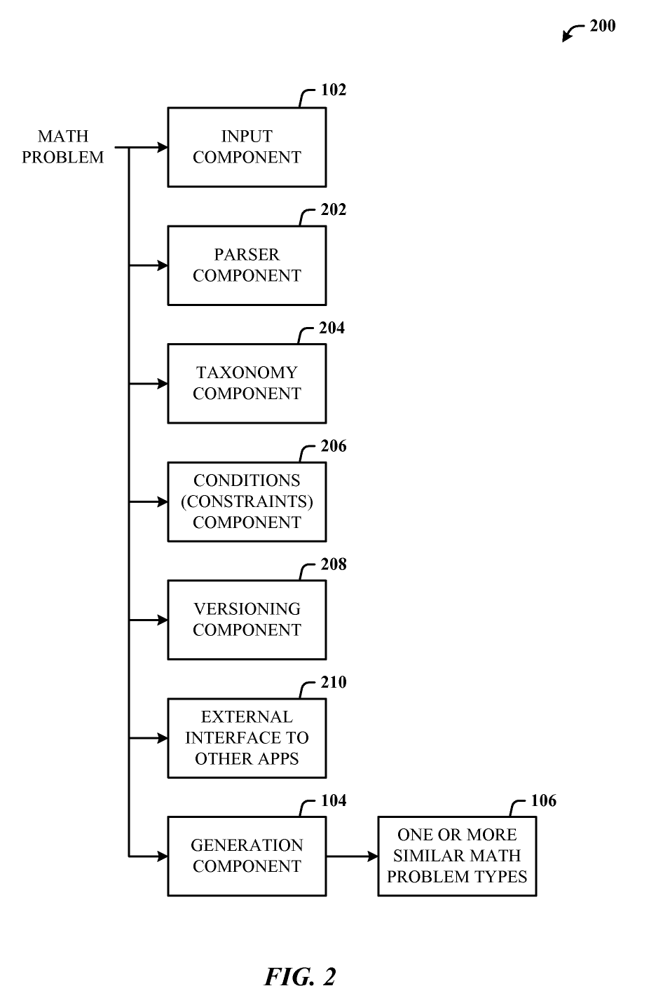

FIG. 2 illustrates a more detailed system 200 for problem generation in accordance with the disclosed architecture. The system 200 includes the input component 102 and generation component 104 of FIG. 1. The user can input the problem using a math editor tool, for example, and for inputting functionality. A user interface (UI) facilitates the insertion of math symbols into the program using a panel of math symbol buttons, for example.

Additionally, the system 200 (e.g., a math engine) includes a parser component 202 for parsing the input math problem into a format that can be interpreted by a math engine. The parser component 202 generalizes the parsed input into a common math expression (e.g., the input math problem of 2x+3=−5 can be generalized to the linear equation form ax+b=c). The math engine can include a structured taxonomy to categorize math problems by problem type.

A taxonomy component 204 facilitates taxonomy processing. If the parsed math problem matches a math problem type in the taxonomy, the parsed math problem is checked against a predefined problem generation table. The table of the component 204 includes entries having row information having problem conditions for common general expressions. If the problem matches one of the table entries, the corresponding table row information is used to intelligently populate the problem conditions used for the generation of similar math problem types.

The table lookup functionality provides more accurate and faster performance for commonly inputted math problems. When this intermediate functionality is called, the assigning conditions algorithm can be bypassed and the conditions are pulled directly from the table entries.

If the problem does not match a taxonomy or is not found in the lookup table, an algorithm is provided as part of a conditions (or constraints) component 206 that calculates a set of conditions which are automatically assigned to the general form. The algorithm constrains parameters to a known parameter set and then intelligently searches through these ranges to find and set conditions appropriately.

The input component 102 includes a problem generation preview display capability that displays conditions information indicated, whether default conditions from the table lookup or user-defined conditions for overriding the default conditions.

The generation component 104 then prompts the user for the number of problems to be generated and the generator algorithm outputs the preset number of problems based on the conditions set. In an alternative embodiment, the algorithm can be set for a default number of problems to be spawned, such as for an exam or quiz.

A versioning component 208 is provided so that the user can generate different versions of problem sets and even individual problems. For example, a teacher can spawn sets of problems in advance for assignments, quizzes or exam purposes and save these sets. In another example, a template can be generated that defines the conditions and sets of input problems that will be used to spawn the test questions. The templates can be stored and retrieved for spawning problems at the desired time. Provided that the conditions (or constraints) are also stored in the template, the difficulty of spawned problems remains substantially the same, yet the problems can be different. This can have a significant effect on reducing or even eliminating cheating. Moreover, each student can be assigned problems that no other student will receive. Thus, cheating is no longer a matter of copying answers.

The templates and versions can be formatted for use with other programs or applications, such as a word processor. Accordingly, an external interface 210 is provided to other applications for receiving the formatted templates. One application type that is commonly known and that can be used is a word processor. In other words, the problem sets can be spawned into a word processor where the user can interact with the problems.

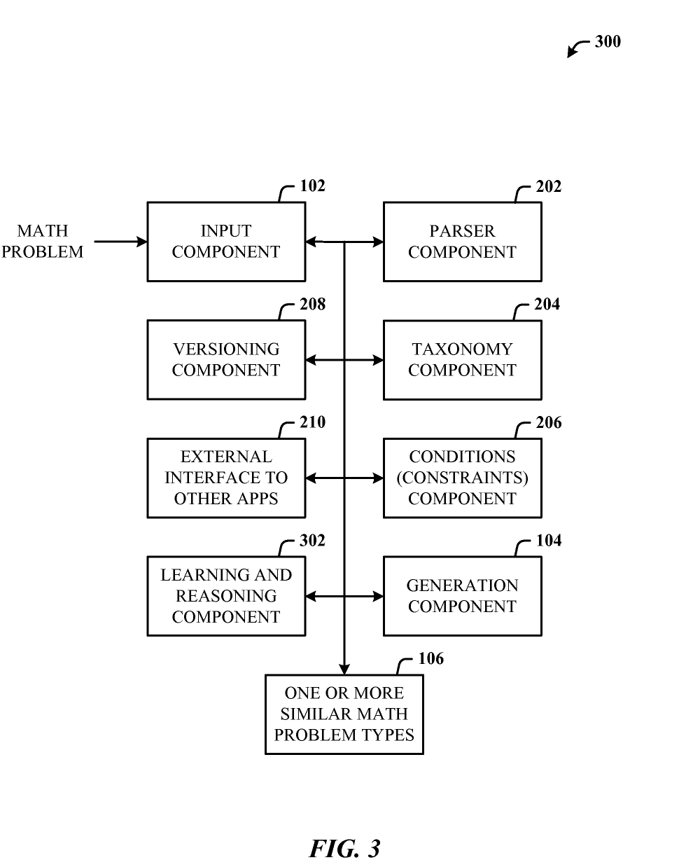

FIG. 3 illustrates a system 300 that employs a machine learning and reasoning (MLR) component 302 which facilitates automating one or more features. The subject architecture (e.g., in connection with selection) can employ various MLR-based schemes for carrying out various aspects thereof. For example, a process for determining what condition to apply based on user information can be facilitated via an automatic classifier system and process.

A classifier is a function that maps an input attribute vector, x=(x₁, x₂, x₃, x₄, . . . , xₙ, where n is a positive integer), to a class label class(x). The classifier can also output a confidence that the input belongs to a class, that is, f(x)=confidence (class(x)). Such classification can employ a probabilistic and/or other statistical analysis (e.g., one factoring into the analysis utilities and costs to maximize the expected value to one or more people) to prognose or infer an action that a user desires to be automatically performed.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, for example, various forms of statistical regression, naive Bayes, Bayesian networks, decision trees, neural networks, fuzzy logic models, and other statistical classification models representing different patterns of independence can be employed. Classification as used herein also is inclusive of methods used to assign rank and/or priority.

As will be readily appreciated from the subject specification, the subject architecture can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be employed to automatically learn and perform a number of functions according to predetermined criteria.

The system 300 includes the components 102, 104, 106, 202, 204, 206, 208 and 210 and associated functionality of FIG. 2. The MLR component 302 interfaces to the other components to learn and reason about data, user activities, and system operations and functionality. For example, based on previous levels of difficulty of a particular problem input, the MLR component 302 can skew or bias the conditions imposed on the common expression to increase or decrease the difficulty of the spawned examples. In another example, the MLR component 302 and associated user behavior with personal information such as log-in information. Based on this information, the difficulty of the spawned problems can be controlled automatically for the user.

The MLR component 302 can be employed to add entries to the taxonomy table. For example, the table can be provided with a default set of taxonomy. However, based on user input that is not included in the table, the table can be updated based on the new types of problems such that future compares are executed from the faster table process rather than the slower algorithmic generation. The MLR component 302 can also present the spawned problems in a certain order such as according to increasing difficulty, for example. In another example, the MLR component 302 can be employed to dynamically respawn new problems in response to user activity. This can be an adaptive testing where if the user performs well on previous examples, the next example is more difficult. Similarly, if the user performs poorly, the next example is less difficult. These are only but a few examples of the utility associated with the MLR component 302.

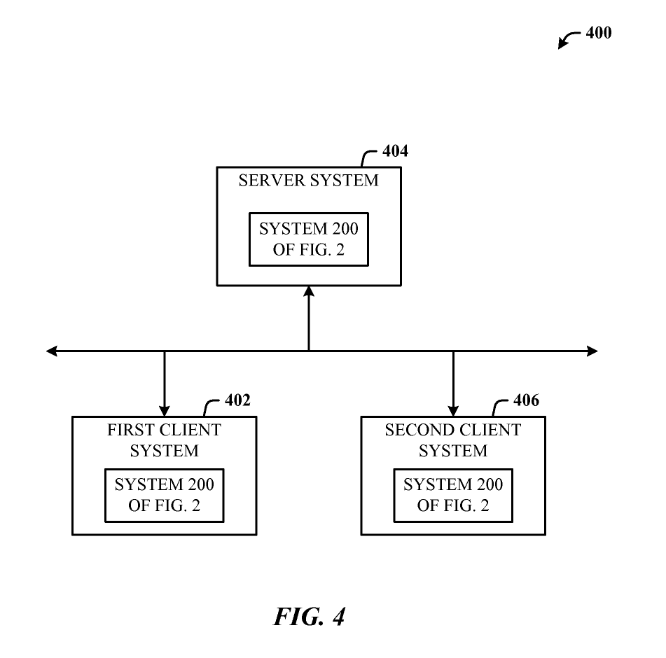

FIG. 4 illustrates a system 400 for providing example problem types in a multi-client environment. A first client 402 includes the system 200 of FIG. 2 for intelligent problem generation. The first client 402 can operate independently from a server 404 or a second client 406 to generate problems for the desired purposes. For example templates can be transmitted to the first client 402 and executed to spawn the similar problem types for an assignment or examination. Alternatively, the first client 402 can access the server system 404 and log-in to a common space (or session) for participating in a class. A session leader (e.g., a teacher) can then offer templates for download to spawn example problems common to some or all of the participants for review or discussion. Alternatively, the examples are spawned only on the server 404 for viewing and interaction by the client users. In yet another example, the first client 402 is in a peer relationship with a second client 406 such that the users can exchange or view problems of the other clients systems.

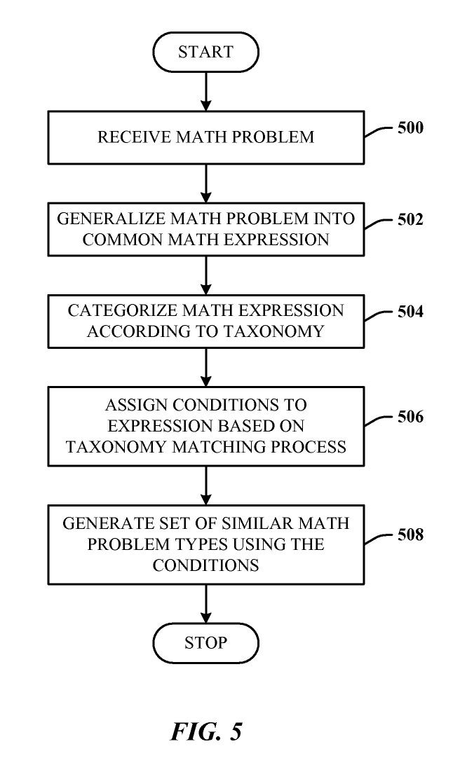

FIG. 5 illustrates a method of generating a problem. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

At 500, a math problem is received via user input. At 502, the math problem is generalized into a common math expression. At 504, the math expression is categorized according to a taxonomy. At 506, conditions are assigned to the expression based on a taxonomy matching process. At 508, a set of similar math problem types is generated using the conditions.

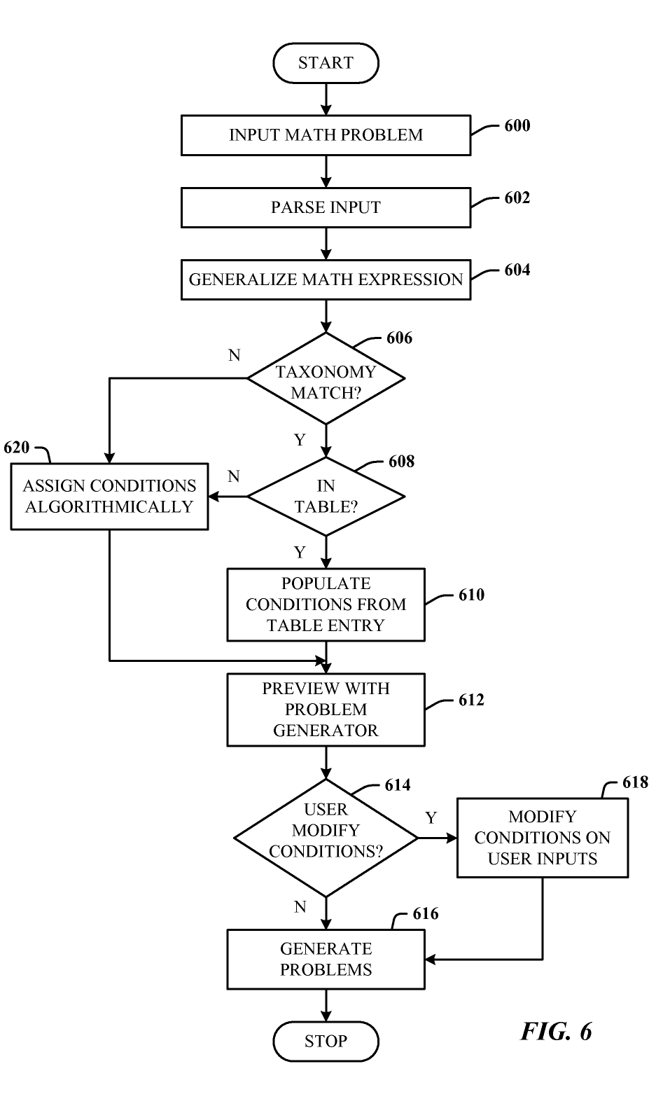

FIG. 6 illustrates a more detailed method of generating a math problem. At 600, a user inputs a math problem using a math editing tool input functionality. Math symbols can be entered using math symbol buttons from the UI of the tool. At 602, the math problem is parsed into a format that can be interpreted by a math engine. At 604, after the math problem is parsed, the parsed math problem is generalized into a common math expression (e.g., 2x+3=−5 generalizes to ax+b=c). At 606, a taxonomy check is performed. A structured taxonomy is employed (e.g., by a math engine) to categorize math problems by problem type using a matching process.

If the parsed math problem matches a math problem type in the taxonomy, flow is from 606 to 608 where the parsed math problem is checked against a predefined problem generation table. If the problem matches one of the table entries, flow is from 608 to 610 where the corresponding table row information is used to intelligently populate the problem conditions that set up the generation of similar math problem types. The table lookup functionality provides more accurate and faster performance for commonly inputted math problems. When this intermediate functionality is called, assigning conditions algorithmically is bypassed and the conditions are pulled directly from the table entries.

At 612, a problem generation preview is displayed with information indicated by the conditions set previously. At 614, if the user chooses not to modify the preset conditions, flow is to 616 where the generation process prompts for the number of problems to be generated and the algorithm outputs the preset number of problems based on the conditions set. If the user chooses to modify the preset conditions, flow is from 614 to 618 where the user's modified conditions overwrite the preset conditions and a new problem generation preview is displayed with updated conditions information. If the conditions set by the user constrain the problem such that the number of problems falls below a threshold (e.g., no problems can be generated), null is returned and an exception is called. The user can then prompted asked to relax some of the constraints (e.g., the common expression ax+b=c, where conditions modified=>xER x>0, a>0, b >0, c<−4, no problem set satisfies this constraint).

At 606, if the problem does not match a taxonomy or at 608, the problem is not found in the lookup table, flow is to 620 where an algorithm calculates a series of conditions which are automatically assigned to the general form. The algorithm constrains parameters to a known set and then intelligently searches through the ranges of parameters to find and set conditions appropriately. The generalized problem can be input into a random generator for creating numbers, values, and variables based on condition boundaries (e.g., assigning conditions algorithm or set by the user), resulting in the construction of specific problems. Note that conventional algorithms that facilitate fast generation of problems that fit constraints can also be employed.

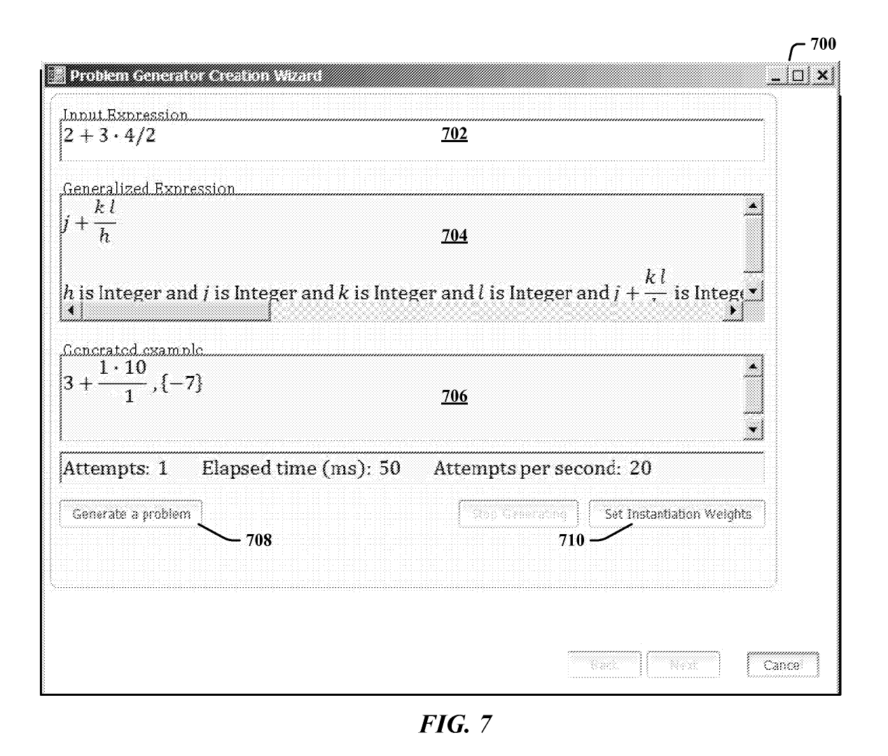

FIG. 7 illustrates a screenshot 700 of a UI wizard for entering a purely numeric math problem and viewing a generalized expression. Here, the problem generator creation wizard 700 includes an Input Expression field 702 for entering a math problem of purely numbers. A Generalized Expression field 704 presents the generalized expression and associated descriptive text. A Generated Example field 706 presents one similar problem type and the answer for the generated problem type. The wizard 700 also presents a selectable option 708 to generate a new example for viewing. Weights can also be applied via a Set Instantiation Weights selector 710. The wizard 700 can also present timing information and attempts information.

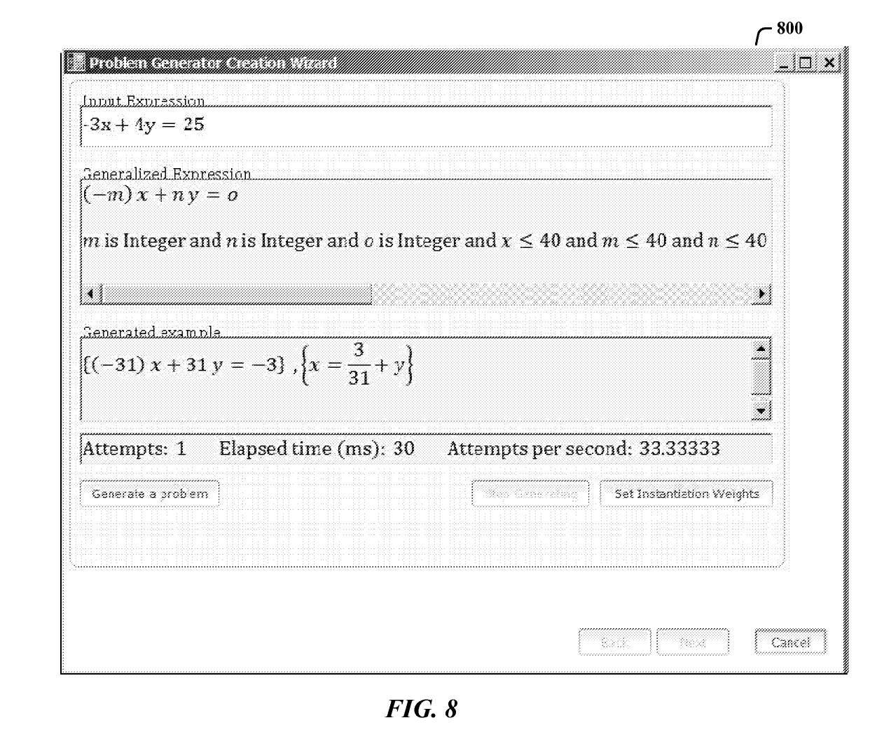

FIG. 8 illustrates a second screenshot 800 of the UI wizard for entering a multi-variable math problem and viewing a generalized expression. Here, the input problem includes multiple variables, and the generalized expression also includes presentation of the conditions such as m is an integer, x≦40, m≦40 and n≦40, and so on. The generated example is then a multi-variable example with the answer presented.

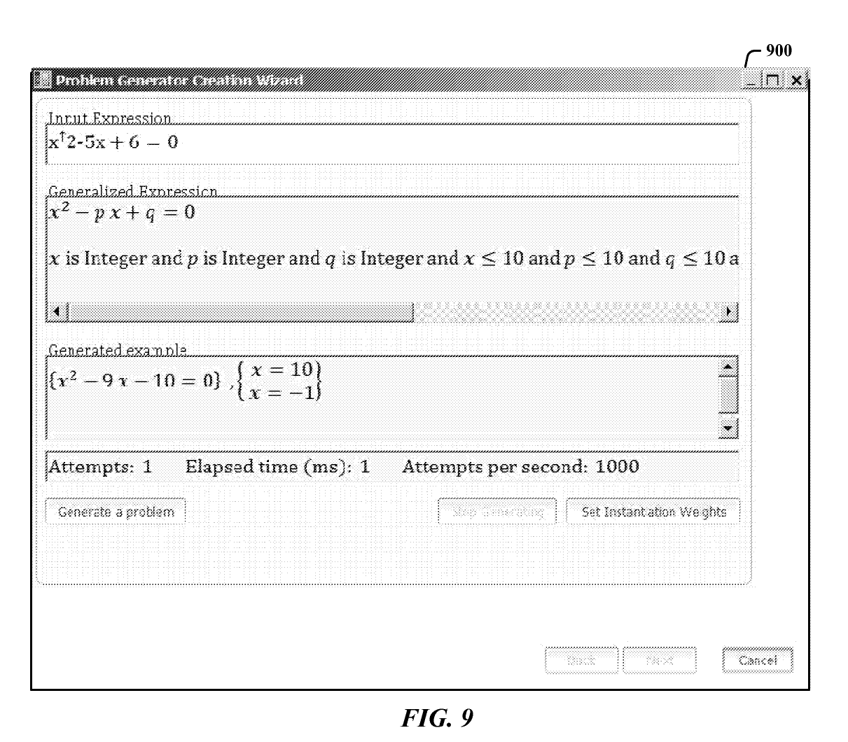

FIG. 9 illustrates a third screenshot 900 of the UI wizard for entering a quadratic math problem and viewing a generalized expression. Here, the generalized expression also includes presentation of a quadratic expression form and the generated example includes a quadratic equation with two solutions.

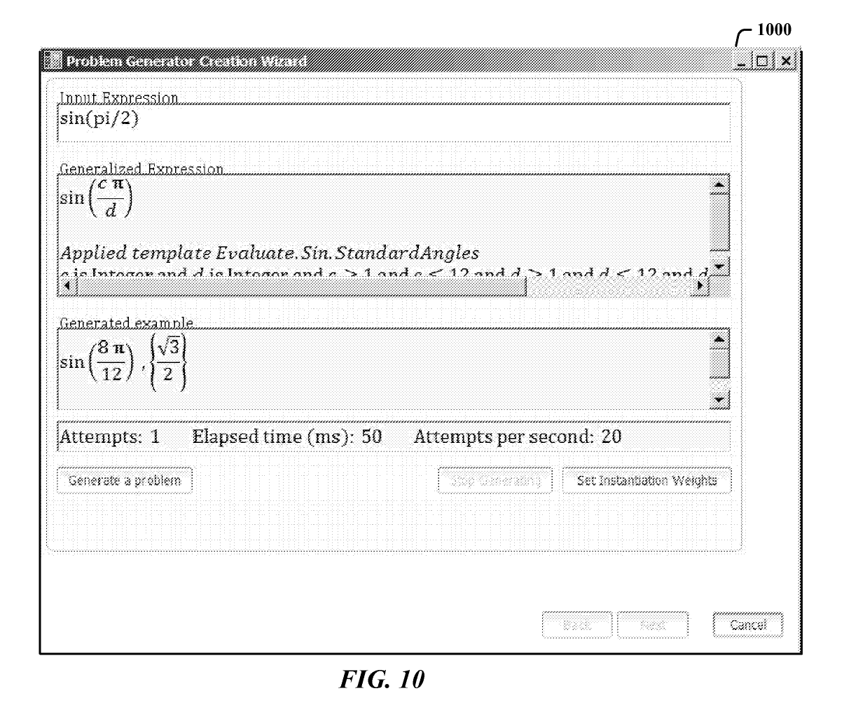

FIG. 10 illustrates a fourth screenshot 1000 of the UI wizard for entering a sine math problem and viewing a generalized expression. Here, the generalized expression also includes presentation of a sine expression form and the generated example includes a sine function with a solution.

While certain ways of displaying information to users are shown and described with respect to certain figures as screenshots, those skilled in the relevant art will recognize that various other alternatives can be employed. The terms “screen,” “screenshot”, “webpage,” “document”, and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

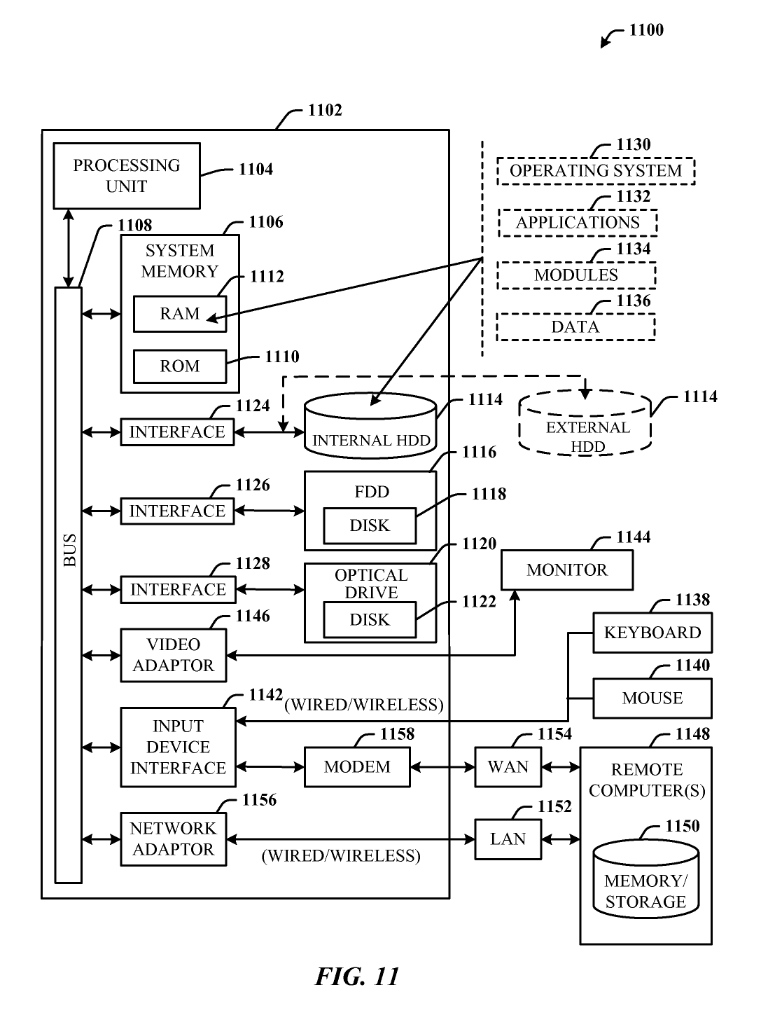

Referring now to FIG. 11, there is illustrated a block diagram of a computing system 1100 operable to execute intelligent problem generation in accordance with the disclosed architecture. In order to provide additional context for various aspects thereof, FIG. 11 and the following discussion are intended to provide a brief, general description of a suitable computing system 1100 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the exemplary computing system 1100 for implementing various aspects includes a computer 1102, the computer 1102 including a processing unit 1104, a system memory 1106 and a system bus 1108. The system bus 1108 provides an interface for system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and RAM 1112, including an operating system 1130, one or more application programs 1132, other program modules 1134 and program data 1136. The one or more application programs 1132, other program modules 1134 and program data 1136 can include the input component 102 and generation component 104, the parser component 202, taxonomy component 204, conditions component 206, versioning component 208, external interface component 210, and MLR component 302, for example.

All or portions of the operating system, applications, modules, and/or data can also be cached in the RAM 1112. It is to be appreciated that the disclosed architecture can be implemented with various commercially available operating systems or combinations of operating systems.

A user can enter commands and information into the computer 1102 through one or more wire/wireless input devices, for example, a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wire and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wire/wireless connectivity to a local area network (LAN) 1152 and/or larger networks, for example, a wide area network (WAN) 1154. Such LAN and WAN networking environments are commonplace in offices and companies, and facilitate enterprise-wide computer networks, such as intranets, all of which may connect to a global communications network, for example, the Internet.

When used in a LAN networking environment, the computer 1102 is connected to the local network 1152 through a wire and/or wireless communication network interface or adapter 1156. The adaptor 1156 may facilitate wire or wireless communication to the LAN 1152, which may also include a wireless access point disposed thereon for communicating with the wireless adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wire and/or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

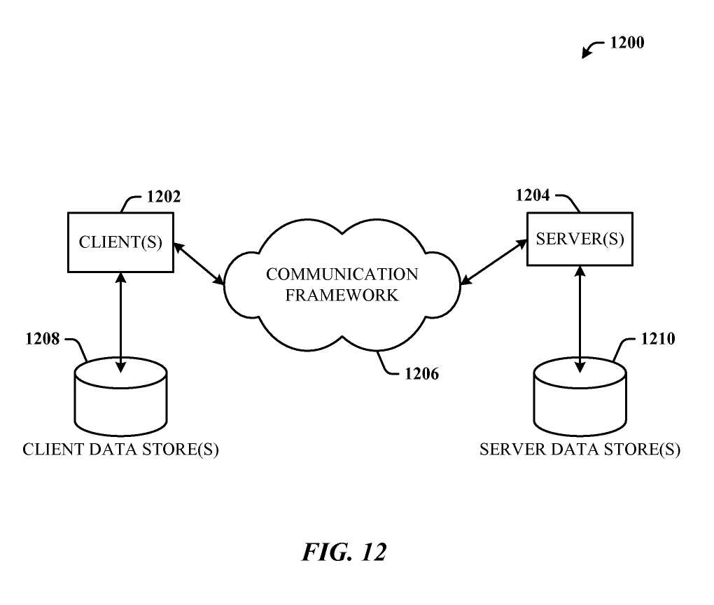

Referring now to FIG. 12, there is illustrated a schematic block diagram of an exemplary client/server computing environment 1200 for intelligent problem generation. The system 1200 includes one or more client(s) 1202. The client(s) 1202 can be hardware and/or software (e.g., threads, processes, computing devices). The client(s) 1202 can house cookie(s) and/or associated contextual information, for example.

The system 1200 also includes one or more server(s) 1204. The server(s) 1204 can also be hardware and/or software (e.g., threads, processes, computing devices). The servers 1204 can house threads to perform transformations by employing the architecture, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wire (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204. The clients 1202 can include the clients 402 and 406, and the servers 1204 can include the server 404, for example.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented problem generation system, comprising:
an input component for receiving a math problem; and
a generation component for algorithmically deriving similar math problem types based on the math problem.

2. The system of claim 1, further comprising a parser component for parsing the math problem according to math operators and numeric symbols utilized in the math problem.

3. The system of claim 2, wherein the parser component generalizes the math problem into a common math expression.

4. The system of claim 1, further comprising a constraints component for imposing conditions on generation of the math problem types.

5. The system of claim 1, further comprising a constraints component for inputting a constraint based on which the generation component derives a set of the similar math problem types, the problem types differing according to difficulty.

6. The system of claim 1, further comprising a constraints component for applying one or more conditions for derivation of the similar math problem types, the conditions based on at least one of user identification information or user academic information.

7. The system of claim 1, further comprising a versioning component for applying version information to the math problem and the similar math problem types.

8. The system of claim 1, further comprising an external interface component for communicating at least one of the math problem or the similar math problem types to a different application.

9. The system of claim 1, wherein the input component includes a customizable user interface via which the math problem is input and the similar math problem types are presented.

10. The system of claim 1, further comprising a taxonomy component for categorizing the math problem according to one of multiple different math categories.

11. The system of claim 1, further comprising a machine learning and reasoning component that employs a probabilistic and/or statistical-based analysis for prognosing or inferring an action that is desired to be automatically performed.

12. A computer-implemented method of generating a problem, comprising:
receiving a math problem;
generalizing the math problem into a common math expression;
categorizing the math expression according to a taxonomy;
assigning conditions to the expression based on a taxonomy matching process; and
generating a set of similar math problem types using the conditions.

13. The method of claim 12, further comprising parsing the math problem into a format suitable for interpretation by a math engine.

14. The method of claim 12, further comprising assigning the conditions algorithmically if the taxonomy matching process fails to find a match.

15. The method of claim 12, further comprising modifying the conditions assigned if a number of problem types in the set is below a threshold value.

16. The method of claim 12, further comprising generating the set using a random number generator that processes the common math expression to create at least one of numbers, values, or variables based on condition boundaries for generating the set.

17. The method of claim 12, further comprising assigning the conditions algorithmically by constraining parameters to a known parameter set and intelligently searching through the parameter set for the conditions to assign.

18. The method of claim 12, wherein the conditions assigned are extracted directly from a lookup table.

19. The method of claim 12, further comprising formatting the set into a common format suitable for use by third-party applications.

20. A computer-implemented system, comprising:
computer-implemented means for receiving a math problem;
computer-implemented means for generalizing the math problem into a common math expression;
computer-implemented means for categorizing the math expression according to a taxonomy;
computer-implemented means for assigning conditions to the expression based on a taxonomy matching process; and
computer-implemented means for generating a set of similar math problem types using the conditions.
